(19) United States
(12) Patent Application Publication
(10) Pub. No.: US 2017/0178176 A1
(43) Pub. Date: Jun. 22, 2017

(54) SYSTEM AND METHOD FOR CREATING AND SEARCHING FOR COUPONS RELATED TO REAL ESTATE

(71) Applicant: Charles Allen, North Augusta, SC (US)

(72) Inventor: Charles Allen, North Augusta, SC (US)

(21) Appl. No.: 15/389,433

(22) Filed: Dec. 22, 2016

Related U.S. Application Data
(60) Provisional application No. 62/270,991, filed on Dec. 22, 2015.

(51) Int. Cl. G06Q 30/02; G06F 17/30

(52) U.S. Cl. CPC G06Q 30/0239; G06F 17/30312; G06F 17/30867; G06Q 50/16

(57) ABSTRACT

Implementations of a real estate coupons (REC) system for creating and searching for coupons related to real estate are provided. Implementations of a REC system according to the present disclosure create, collect, store, and display real estate related coupons either in a visual aerial map, database format, list, color-coded diagram, or any other format. In some implementations, a REC system according to the present disclosure create and store coupons based on input from users (e.g., real estate related vendors) and visually display the coupons to consumers (e.g., buyers or renters) upon query. In some implementations, the REC system retrieves real estate information from, for example, a multiple listing service (MLS) to extract discount information associated with a property and automatically create and store the coupon.

### CROSS REFERENCE TO RELATED APPLICATION

This application claims the benefit of U.S. Patent Application Ser. No. 62/270,991, which was filed on Dec. 22, 2015, and is incorporated herein by reference in its entirety.

### TECHNICAL FIELD

This disclosure relates to implementations of a system and method for creating and searching for coupons related to real estate.

### BACKGROUND

Discounts for real estate exist. For example, U.S. Patent Appl. Pub. No. 2002/0077893 (“'893 Patent Appl.”) discloses a real estate rebate system and method More specifically, the '893 Patent Appl. discloses that when a potential buyer accesses a host website, the potential buyer is presented with a fill-in style form to capture a profile of the potential buyer. Thereafter, a list of candidate properties that match the buyer's profile is presented to the buyer and the buyer selects properties of interest. The '893 Patent Appl. discloses that the host then prepares a personalized rebate coupon and delivers the rebate coupon to the buyer using a Web browser or by e-mail or regular mail.

There does not exist a system for generating, storing, searching for, and displaying coupons for real estate and coupons related to real estate.

### BRIEF DESCRIPTION OF THE DRAWINGS

FIG. 1 illustrates an example website layout of an real estate coupons system according to an implementation of the present disclosure.

FIGS. 2 and 3 illustrate example environments for creating and searching for coupons using a real estate coupons system according to implementations of the present disclosure.

FIG. 4 illustrates an example computer system, which may be used with implementations of the present invention.

FIGS. 5A-5E illustrates example implementations of the results of a coupon search.

FIGS. 6A-6G illustrate example implementations of real estate related coupons according to the present disclosure.

FIG. 7 illustrates an implementation of an example user interface for selecting search criteria for real estate related coupons.

### DETAILED DESCRIPTION

Implementations of a real estate coupons (REC) system for creating and searching for coupons related to real estate are provided.

Implementations of a REC system according to the present disclosure create, collect, store, and display real estate related coupons either in a visual aerial map, database format, list, color-coded diagram, or any other format.

In some implementations, a REC system according to the present disclosure create and store coupons based on input from users (e.g., real estate related vendors) and visually display the coupons to consumers (e.g., buyers or renters) upon query. In some implementations, the REC system retrieves real estate information from, for example, a multiple listing service (MLS) to extract discount information associated with a property and automatically create and store the coupon.

In some implementations, real estate related coupons may include, but are not limited to, realtor discounts, builder discounts, contractor discounts, realtor to realtor discounts, builder to realtor discounts, lender discounts, attorney discounts, home warranty discounts, appraiser discounts, pest control discounts, termite inspection discounts, moving company discounts, interior decorating discounts, buyer discounts, seller discounts, For Sale By Owner discounts, discounts related to plumbing, heating & air, electrical, flooring, painting, sheetrock, lighting, roofing, cement, framing, siding, brick, stone, blinds, appliances, cabinets, countertops, windows, landscaping, doors, man caves, plumbing fixtures, or any other savings, offering, bonus, or discounts related to real estate, home improvement, home repair, or residential structures. In some implementations, a real estate related coupon may have an expiration date.

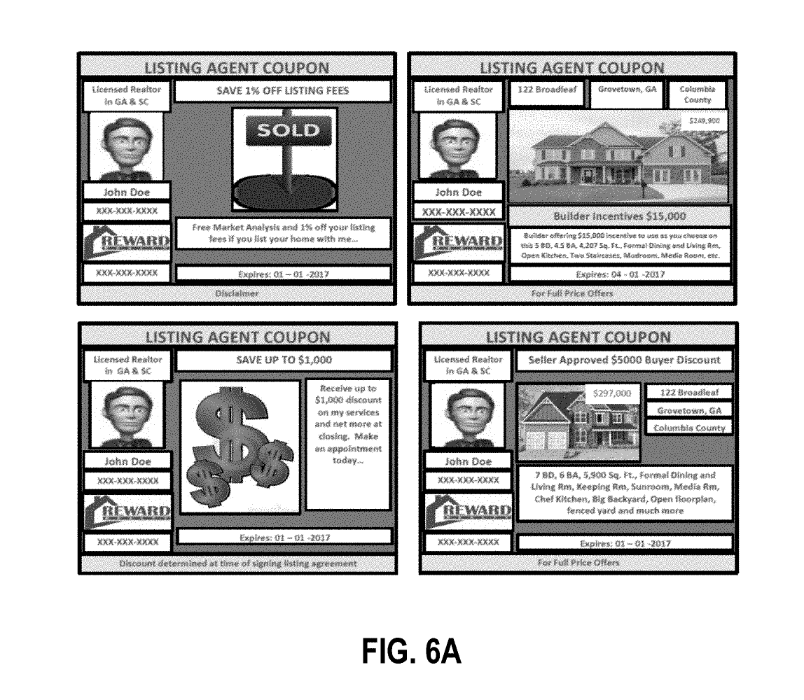

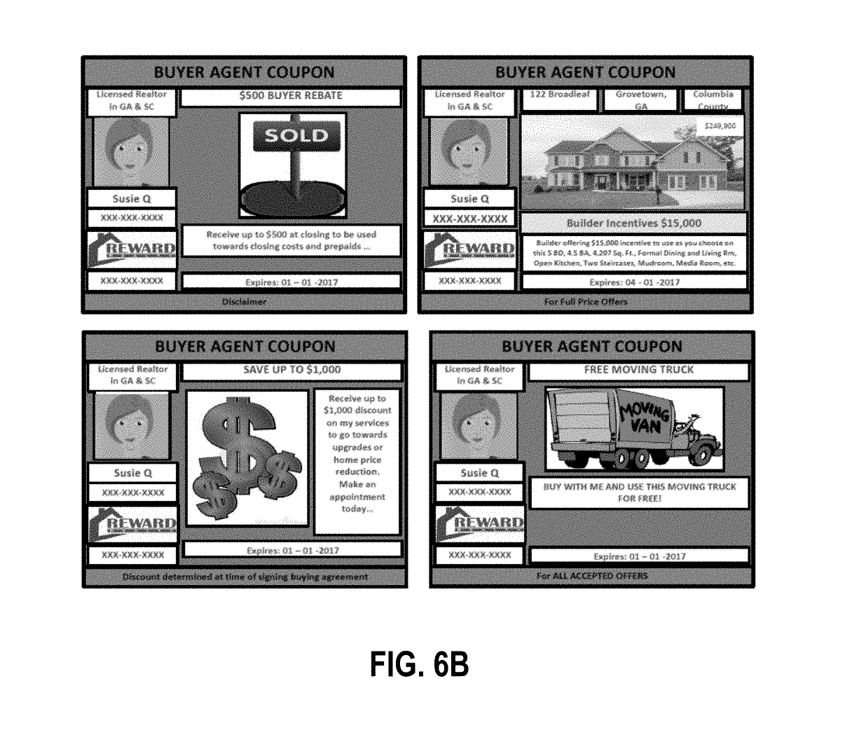

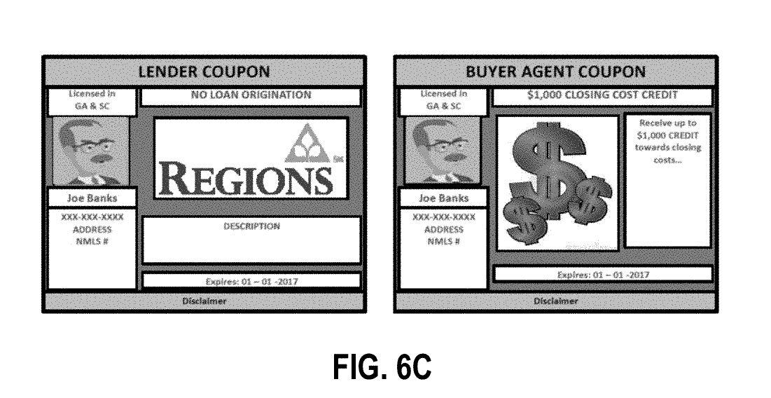

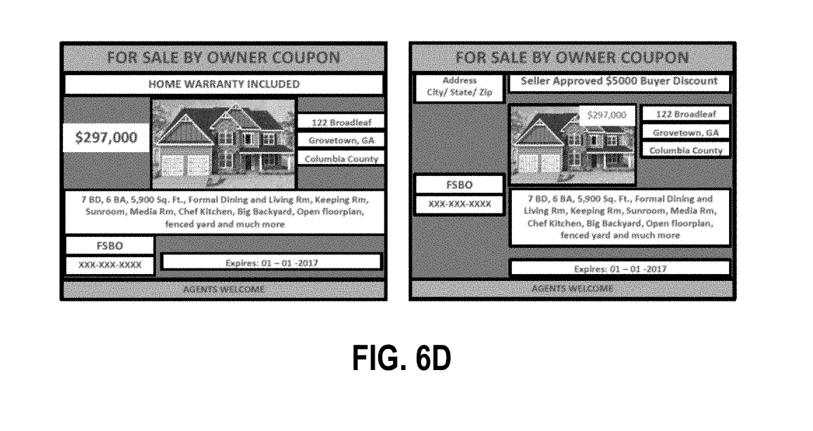

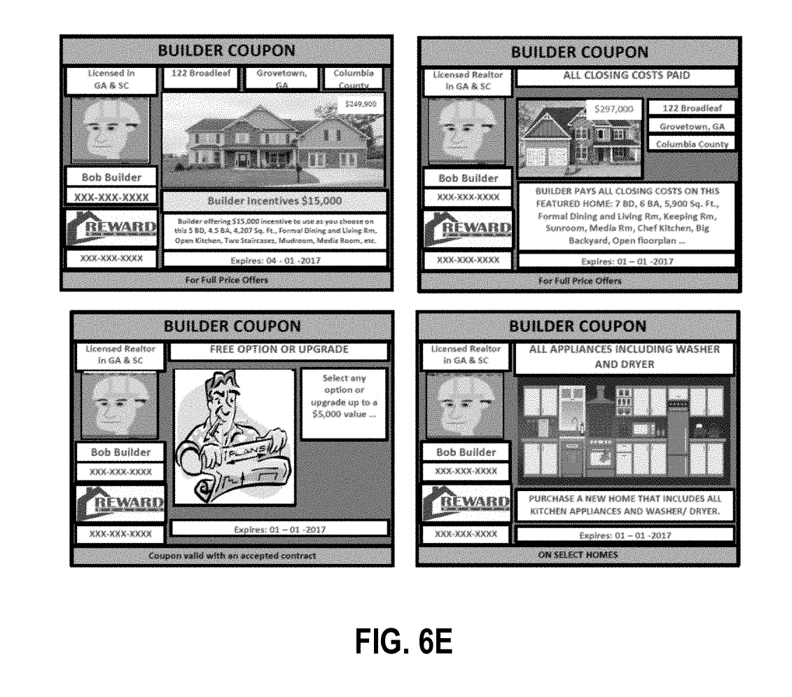

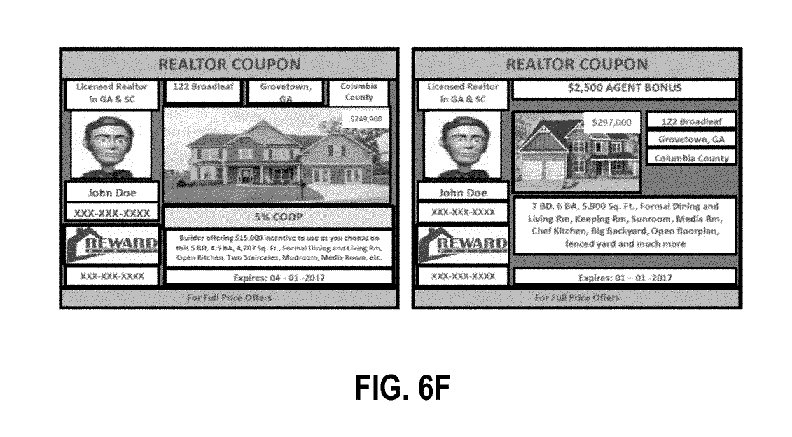

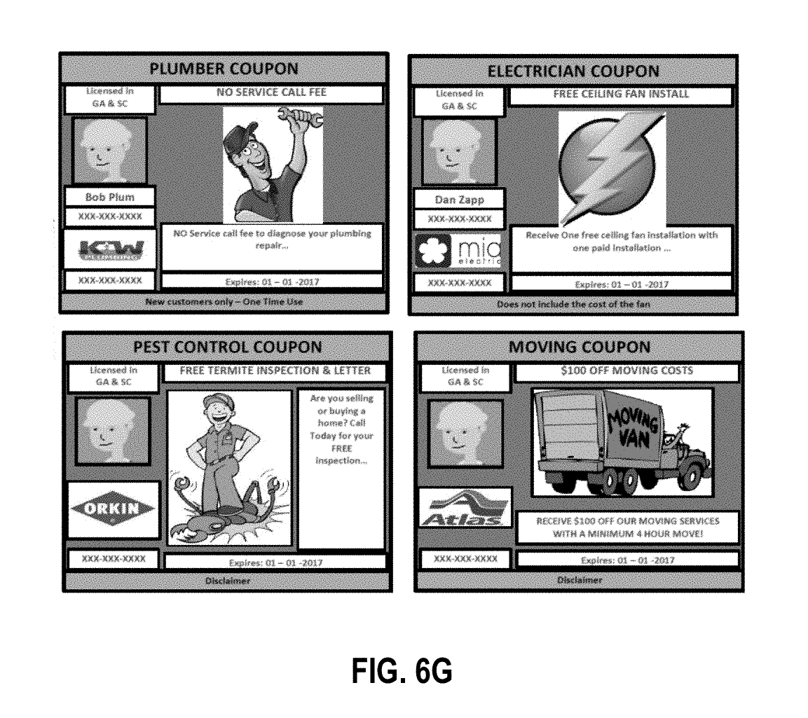

FIGS. 6A-6G illustrates example implementations of real estate related coupons according to the present disclosure. FIG. 6A illustrates example implementations of real estate related coupons from listing agents according to the present disclosure. FIG. 6B illustrates example implementations of real estate related coupons from selling agents according to the present disclosure. FIG. 6C illustrates example implementations of real estate related coupons from lenders according to the present disclosure. FIG. 6D illustrates example implementations of real estate related coupons from owners according to the present disclosure. FIG. 6E illustrates example implementations of real estate related coupons from builders according to the present disclosure. FIG. 6F illustrates example implementations of real estate related coupons from builders or listing agents to realtors according to the present disclosure. FIG. 6G illustrates example implementations of other real estate related coupons according to the present disclosure.

For example, a real estate related coupon may include an offering (e.g., discount) on listing fees or other listing agent fees. As another example, a real estate related coupon may include an offering (e.g., discount, money) from a listing agent, buyer agent, or builder for building expenses, sales price, upgrades, closing costs, buyer agent fees, or other offerings. As another example, a real estate related coupon may include an offering (e.g., discount, money) from a lendor for closing costs. As another example, a real estate related coupon may include an offering (e.g., discount, money) from an owner for a warranty or sales price. In some implementations, real estate related coupons comprise bonuses to buyer's agent.

Implementations of a REC system according to the present disclosure allow consumers to search for real estate related coupons. In some implementations, a REC system according to the present disclosure allow buyers to search for real estate related coupons. In some implementations, a REC system according to the present disclosure allow realtors to search for real estate related coupons from listing agents and builders. In some implementations, a REC system according to the present disclosure presents coupons directed to buyers on a separate map than coupons directed to realtors. In some implementations, a REC system according to the present disclosure restrict access to coupons directed to realtors to realtors such that regular buyers cannot view these coupons. In some implementations, access is restricted by verifying that a user is a realtor. In some implementations, a user may be verified as a realtor based on a realtor license number provided by the user. In some implementations, a user is verified as a realtor based on a brokerage firm identification number provided by the user.

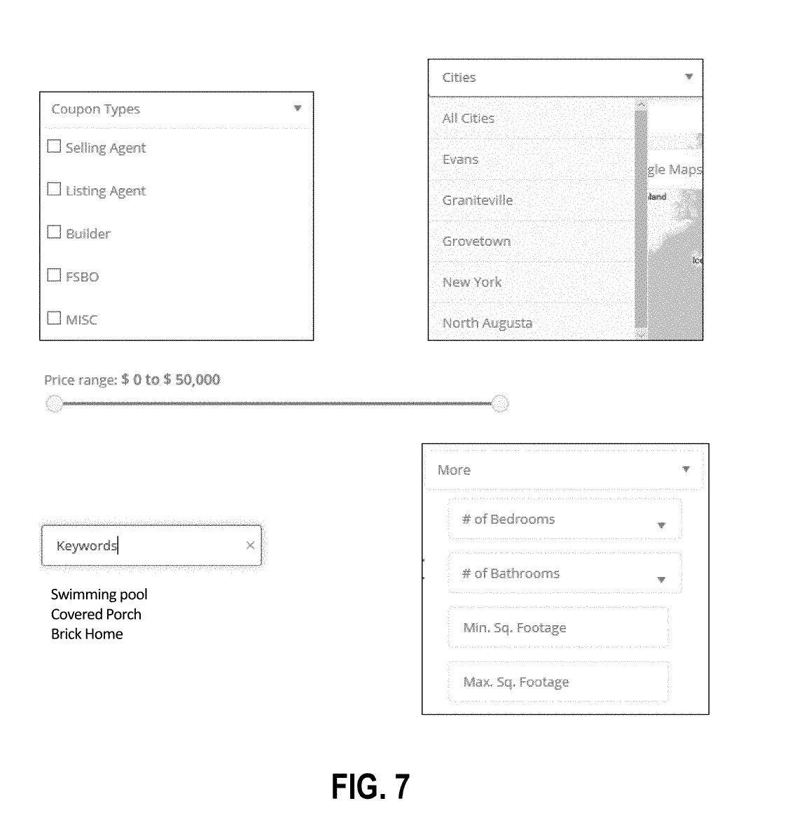

In some implementations, a user may search the REC system based on a real estate related search criteria and then view all corresponding real estate related coupons or discounts available based on the search criteria. For example, a user may search for real estate related coupons based on coupon type (e.g., coupon by selling agent, listing agent, builder, owner, or other), location, offering amount, real estate features (e.g., number of bedrooms, square footage, brick home, etc.), keywords, or any other search criteria. FIG. 7 illustrates an implementation of an example user interface for selecting search criteria for real estate related coupons.

In some implementations, a user can search for real estate properties and coupons related to these real estate properties. In some implementations, a user can search for coupons related to a specific realtor, builder, or other vendor.

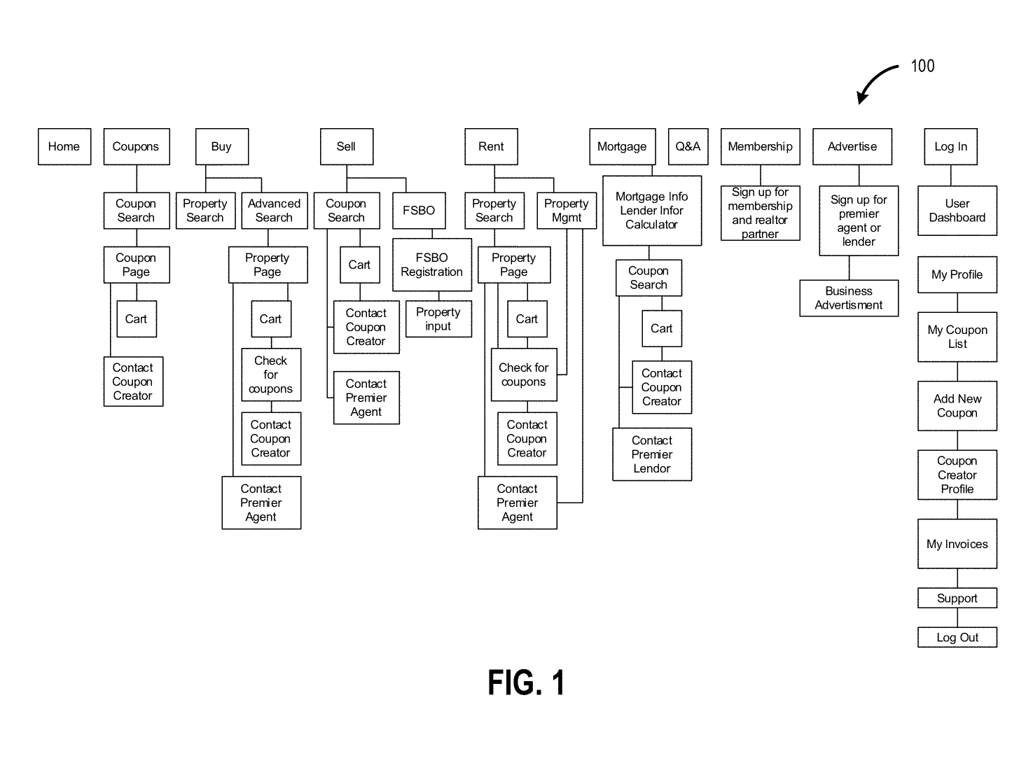

FIG. 1 illustrates an example website layout 100 of an REC system according to an implementations of the present disclosure. In some implementations, the REC system may comprise one or more elements or any combination of elements illustrated in FIG. 1.

In general, in some implementations, an REC system according to the present disclosure comprises a website that allows a user to search not only for real estate properties for sale or rent but also for coupons that offer discounts on specific properties, locations, or geographic area.

In some implementations, the REC system offers a membership program for a fee to realtors, builders, lenders, or any other vendor that wants to offer discounts by creating coupons on the REC system.

In some implementations, a coupon module will allow users (e.g., vendors such a realtor, builder, lender, seller, home inspector, appraiser, or any other product or service provider) to create and maintain their coupons. In some implementations, once a coupon is created and stored in the REC system, a consumer (e.g., a buyer or renter) using the REC system can print the coupon and contact the coupon offeror directly.

In some implementations, a coupon may be created and associated with or linked to a specific address or house. In some implementations, a coupon may be created and associated with or linked to a subdivision, city, or other geographical area.

In some implementations, a coupon may be created and associated with or linked to a vendor (e.g., such a realtor, builder, lender, seller, home inspector, appraiser, or any other product or service provider).

In some implementations, a coupon may be created and associated with or linked to a category such as: Realtor, Builder, Lender, For Sale By Owner (FSBO), or Misc (e.g., Home Inspector, Appraiser, Security, Pest Control, etc.).

In this way, the REC system can display coupons related to a search for real estate at a particular location, subdivision, or geographical area or display coupons related to a particular vendor or category. In some implementations, coupons stored in the REC system can be searched and displayed based on a combination of criteria (e.g., location, vendor, category and/or any other criteria).

In some implementations, the REC system coupon module allows the coupon creator (e.g., vendors) to set a discount based on a dollar amount or a percentage. In some implementations, the REC system coupon module allows the coupon creator to include wording that the creator wants to place on the coupon.

In some implementations, coupons may have a uniform look throughout the site. In some implementations, the creator may have the option to upload an image to be placed on the coupon. In some implementations, the creator may enter text on a pre-defined layout.

In some implementations, the REC system coupon module allows the coupon creator to set an expiration date.

In some implementations, the REC system coupon module allows the coupon creator (e.g., vendors) to enter exclusions and/or restrictions associated with a coupon.

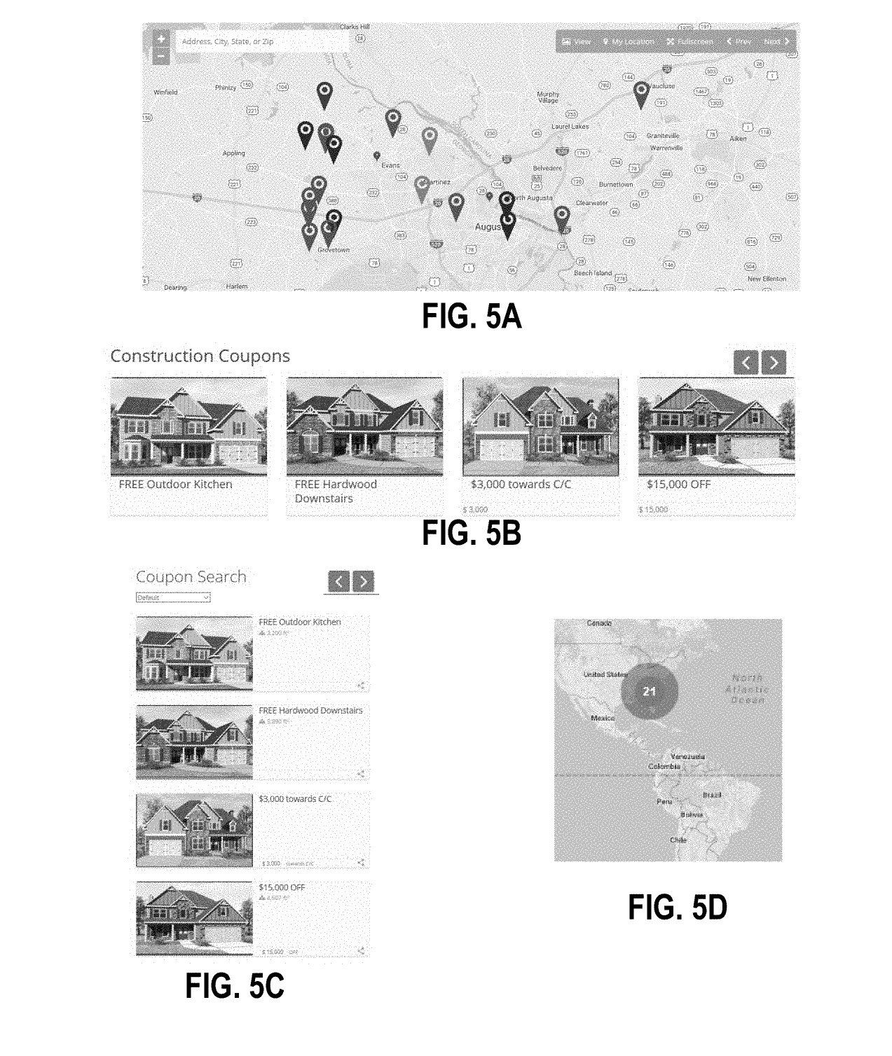

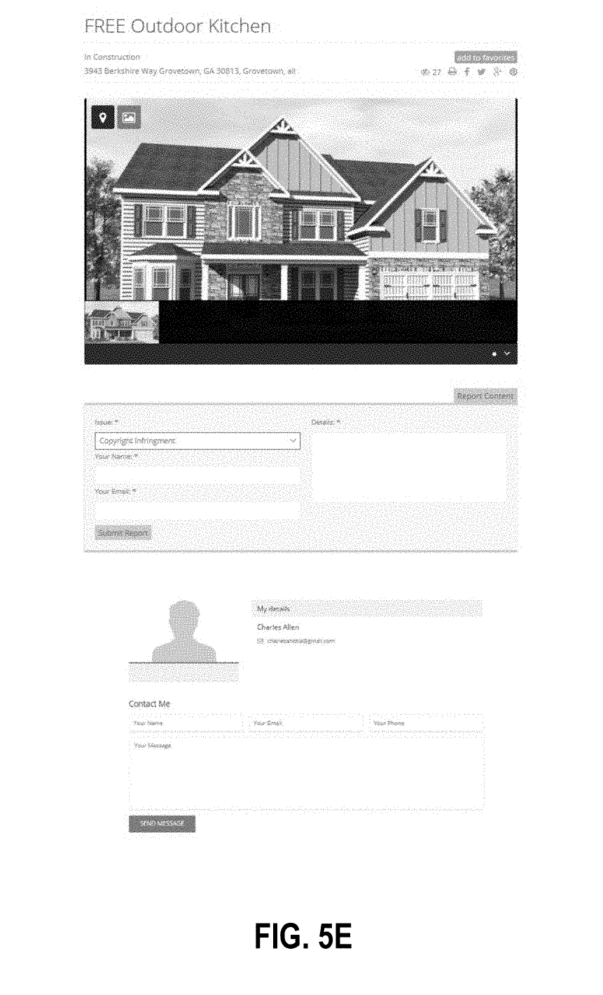

FIGS. 5A-5E illustrate example implementations of the results of a coupon search. In some implementations, the REC system may display coupon search results on a map as shown in FIG. 5A. In some implementations, a couple search may be presented on a map with indications of coupons based on search criteria. In some implementations, the indications may be color-coded based on coupon type. In some implementations, the location of an indication on the map corresponds to the location of the underlying real estate. In some implementations, the REC system may geolocate and display coupons based on the location of the user. In some implementations, the REC system may display coupon search results in full screen.

In some implementations, the REC system may display coupon search results using a “next” and “previous” feature as shown in FIGS. 5B and 5C.

In some implementations, the REC system may display coupon search results on a map using spider pins for coupons using the same address or coupons in the same geographical area for example as shown in FIG. 5D.

In some implementations, the REC system is configured so that a user may report a coupon for a violation. In some implementations, the site administrator may receive an email from the REC system of the report. In this way, the site administrator may inspect the coupon and may remove or modify the coupon.

In some implementations, the REC system allows users to save coupons for easy access or to contact each coupon creator or site administrator through a contact function as shown in FIG. 5E.

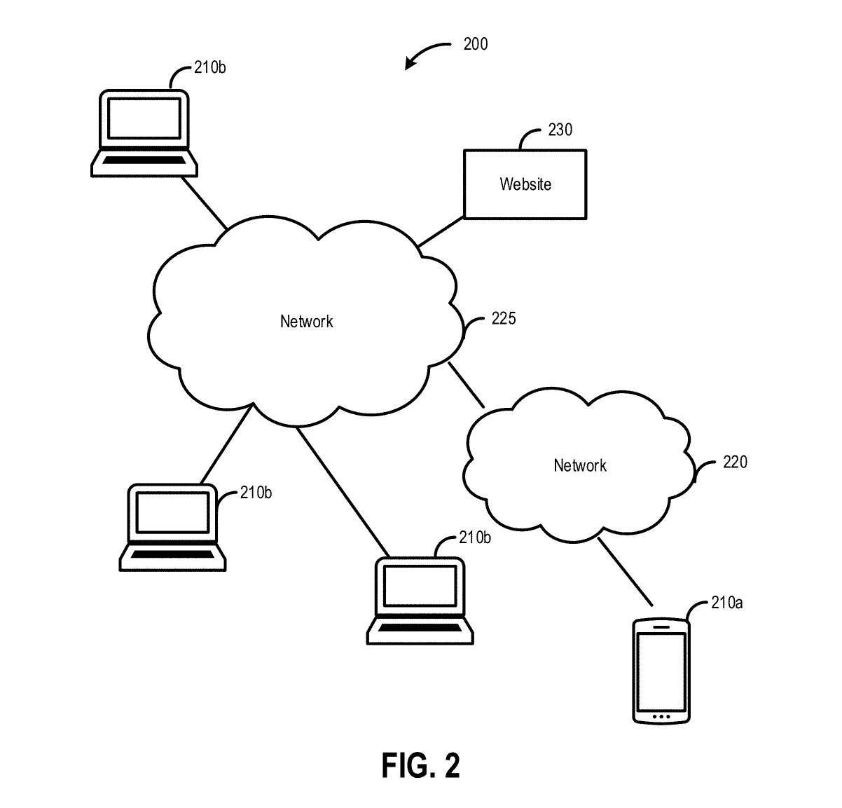

FIG. 2 illustrates an example environment 200 for creating and searching for coupons using a real estate coupons (REC) system (see, e.g., FIG. 1) according to the present disclosure.

As shown in FIG. 2, the environment 200 can include client devices 210a and 210b (collectively client device 210), a wireless cellular network 220, a network 225, and a website 230. Client devices 210a and 210b are depicted as a mobile phone 210a and desktop computer 210b, respectively, but client devices 210 may comprise any type of computing device, such as a desktop computer system, a laptop, cellular phone, a smart device, a mobile telephone, a tablet-style computer, or any other device capable of wireless or wired communication.

In some implementations, the client device 210a can connect to the network 225 through a wireless cellular network 220, such as GPRS-based and CDMA-based wireless networks, as well as 802.16 WiMax and long-range wireless data networks.

Client devices 210a and 210b can interact with the website 230 via an application, such as a web browser or a native application, residing on the client devices 210a and 210b to access the REC systems. In some implementations, a client device 210 may be used to access the REC system, for example, by a consumer to search for coupons or by a vendor to create coupons.

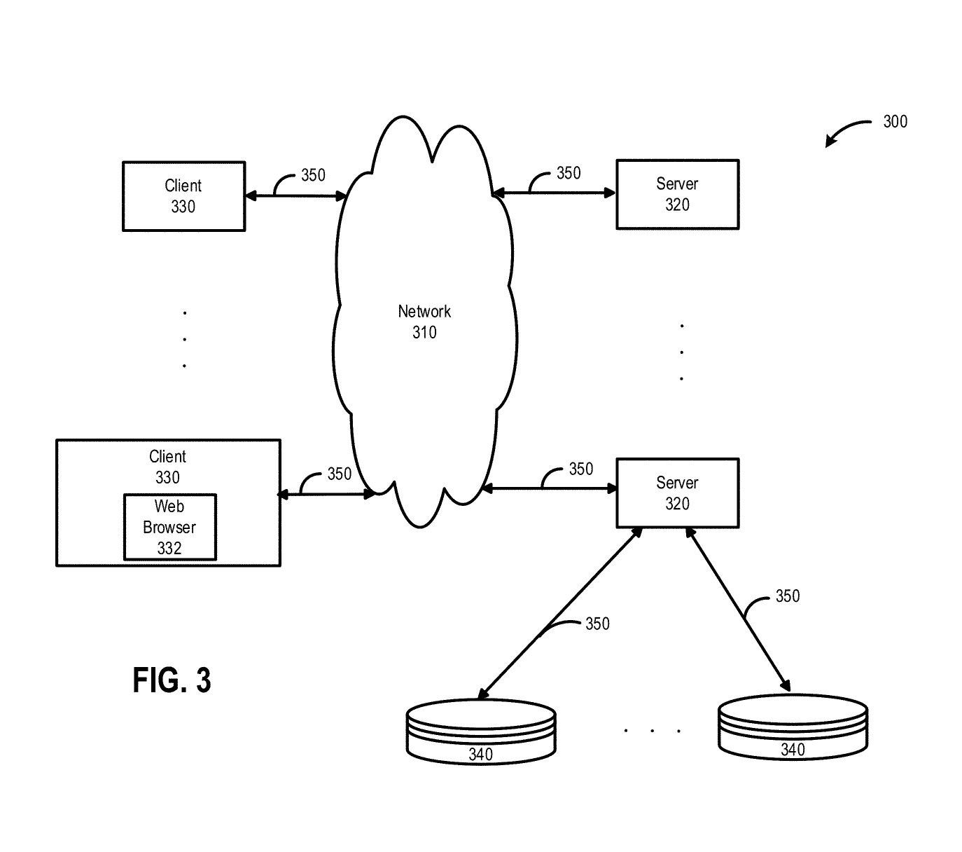

FIG. 3 illustrates another example environment 300 for creating and searching for coupons using a real estate coupons (REC) system (see, e.g., FIG. 1) according to the present disclosure.

The example environment 300 can include a network 310, one or more servers 320, and one or more clients 330.

The example environment 300 also can include one or more data storage 340 linked to one or more servers 320. Particular embodiments may be implemented in network environment 300.

For example, applications used to render the user interfaces to perform the functions described above (e.g., coupon creation, coupon search, etc.) may be written in software programs hosted by one or more servers 320.

In some implementations, network 310 may be an intranet, an extranet, a virtual private network (VPN), a local area network (LAN), a wireless LAN (WLAN), a wide area network (WAN), a metropolitan area network (MAN), a portion of the Internet, or another network 310 or a combination of two or more such networks 310. The present disclosure contemplates any suitable network 310.

One or more links 350 couple a server 320 or a client 330 to network 310. In some implementations, one or more links 350 each can include one or more wired, wireless, or optical links 350. In some implementations, one or more links 350 each can include an intranet, an extranet, a VPN, a LAN, a WLAN, a WAN, a MAN, a portion of the Internet, or another link 350 or a combination of two or more such links 350. The present disclosure contemplates any suitable links 350 coupling servers 320 and clients 330 to network 310.

In some implementations, each server 320 may be a unitary server or may be a distributed server spanning multiple computers or multiple datacenters. Servers 320 may be of various types, such as, for example and without limitation, web server, file server, application server, exchange server, database server, or proxy server. In some implementations, each server 320 may include hardware, software, or embedded logic components or a combination of two or more such components for carrying out the appropriate functionalities implemented or supported by server 320. For example, a web server is generally capable of hosting websites containing web pages or particular elements of web pages. More specifically, a web server may host HTML files or other file types, or may dynamically create or constitute files upon a request, and communicate them to clients 330 in response to HTTP or other requests from clients 330. A database server is generally capable of providing an interface for managing data stored in one or more data stores.

In some implementations, one or more data storages 340 may be communicatively linked to one or more servers 320 via one or more links 350. In some implementations, data storages 340 may be used to store various types of information. In some implementations, the information stored in data storages 340 may be organized according to specific data structures. In particular embodiment, each data storage 340 may be a relational database. Particular embodiments may provide interfaces that enable servers 320 or clients 330 to manage, e.g., retrieve, modify, add, or delete, the information stored in data storage 340.

In some implementations, each client 330 may be an electronic device including hardware, software, or embedded logic components or a combination of two or more such components and capable of carrying out the appropriate functions implemented or supported by client 330. For example and without limitation, a client 330 may be any type of computing device such as a desktop computer system, a laptop, a smartphone, a mobile telephone, a tablet-style computer, or any other handheld electronic device. The present disclosure contemplates any suitable clients 330. A client 330 may enable a network user at client 330 to access network 330. A client 330 may enable its user to communicate with other users at other clients 330.

A client 330 may have a web browser 332, such as MICROSOFT INTERNET EXPLORER, GOOGLE CHROME, MOZILLA FIREFOX, or any other future developed web browser and may have one or more add-ons, plug-ins, or other extensions. A user at client 330 may enter a Uniform Resource Locator (URL) or other address directing the web browser 332 to a server 320, and the web browser 332 may generate a Hyper Text Transfer Protocol (HTTP) request and communicate the HTTP request to server 320. Server 320 may accept the HTTP request and communicate to client 230 one or more Hyper Text Markup Language (HTML) files responsive to the HTTP request. Client 330 may render a web page based on the HTML files from server 320 for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

In some implementations, a client 330 having a web browser 332 can connect to a server 320 to use the REC system for creating or searching for coupons. In some implementations, input received from an user (e.g., coupon information) may be stored in a data storage 340 communicatively linked to the servers 320.

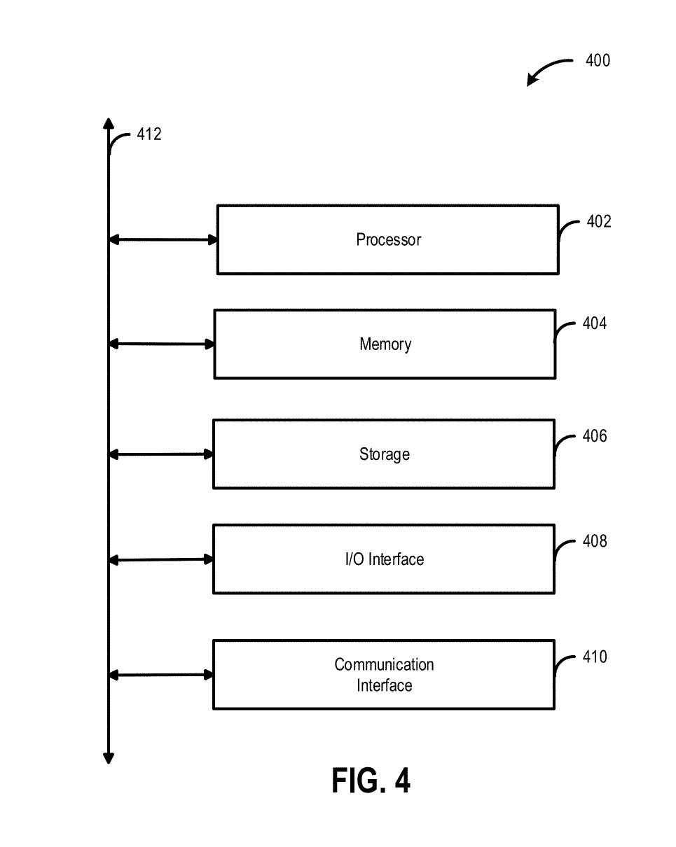

FIG. 4 illustrates an example computer system 400, which may be used with some embodiments of the present invention. This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop, an interactive kiosk, a mainframe, a mesh of computer systems, a mobile telephone, a personal digital assistant (PDA), a server, or a combination of two or more of these. Where appropriate, computer system 400 may include one or more computer systems 400; be unitary or distributed; span multiple locations; span multiple machines; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In some implementations, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In some implementations, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In some implementations, processor 402 may include one or more internal caches for data, instructions, or addresses. The present disclosure contemplates processor 402 including any suitable number of any suitable internal caches, where appropriate. As an example and not by way of limitation, processor 402 may include one or more instruction caches, one or more data caches, and one or more translation look-aside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In some implementations, processor 402 may include one or more internal registers for data, instructions, or addresses. The present disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In some implementations, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In some implementations, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In some implementations, one or more memory management units (MMUs) reside between processor 402 and memory 404 and facilitate accesses to memory 404 requested by processor 402. In some implementations, memory 404 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. The present disclosure contemplates any suitable RAM. Memory 404 may include one or more memories 402, where appropriate. Although this disclosure describes and illustrates particular memory, this disclosure contemplates any suitable memory.

In some implementations, storage 406 includes mass storage for data or instructions. As an example and not by way of limitation, storage 406 may include an HDD, a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In some implementations, storage 406 is non-volatile, solid-state memory. In some implementations, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In some implementations, I/O interface 408 includes hardware, software, or both providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In some implementations, communication interface 410 includes hardware, software, or both providing one or more interfaces for communication (such as, for example, packet-based communication) between computer system 400 and one or more other computer systems 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In some implementations, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101.

This disclosure contemplates one or more computer-readable storage media implementing any suitable storage. In some implementations, a computer-readable storage medium implements one or more portions of processor 402 (such as, for example, one or more internal registers or caches), one or more portions of memory 404, one or more portions of storage 406, or a combination of these, where appropriate. In some implementations, a computer-readable storage medium implements RAM or ROM. In some implementations, a computer-readable storage medium implements volatile or persistent memory. In some implementations, one or more computer-readable storage media embody software. Herein, reference to software may encompass one or more applications, bytecode, one or more computer programs, one or more executables, one or more instructions, logic, machine code, one or more scripts, or source code, and vice versa, where appropriate. In some implementations, software includes one or more application programming interfaces (APIs). This disclosure contemplates any suitable software written or otherwise expressed in any suitable programming language or combination of programming languages. In some implementations, software is expressed as source code or object code. In some implementations, software is expressed in a higher-level programming language, such as, for example, C, Perl, or a suitable extension thereof. In some implementations, software is expressed in a lower-level programming language, such as assembly language (or machine code). In some implementations, software is expressed in JAVA. In some implementations, software is expressed in Hyper Text Markup Language (HTML), Extensible Markup Language (XML), or other suitable markup language.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. For example. it will apparent to one of ordinary skill in the art that the invention may be used with any electronic network service, even if it is not provided through a website. Any computer-based system that provides networking functionality can be used in accordance with the present invention even if it relies, for example, on e-mail, instant messaging or other forms of peer-to-peer communications, and any other technique for communicating between users. The invention is thus not limited to any particular type of communication system, network, protocol, format or application.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

While the foregoing processes and mechanisms can be implemented by a wide variety of physical systems and in a wide variety of network and computing environments, the server or computing systems described below provide example computing system architectures for didactic, rather than limiting, purposes.

The present invention has been explained with reference to specific embodiments. For example, while embodiments of the present invention have been described as operating in connection with a network system, the present invention can be used in connection with any communications facility that allows for communication of messages between users, such as an email hosting site. Other embodiments will be evident to those of ordinary skill in the art. It is therefore not intended that the present invention be limited, except as indicated by the appended claims.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

The present disclosure encompasses all changes, substitutions, variations, alterations, and modifications to the example embodiments herein that a person having ordinary skill in the art would comprehend.

1. A computer-implemented method, the method comprising:
receiving discount information for goods or services related to real estate at a first computing device wherein the discount information is transmitted over a network from a plurality of computing devices wherein each of the discount information at least comprises a geographical scope of the discount and an amount of the discount;
storing the discount information in data storage;
receiving a request for discount information for a good or service related to real estate wherein the request is transmitted over a network from a second computing device and the request for discount information comprises a geographical scope;
searching for and retrieving discount information stored in the data storage based on the request for discount information;
transmitting information to render a user interface on the second computing device wherein the information transmitted comprises discount information including geographical information retrieved from data storage based on the request for discount information and wherein the user interface comprises a map and indicia of discount information positioned on the map based on the geographical information associated with the discount information.

2. The computer-implemented method of claim 1, the method further comprising
displaying a user interface for inputting discount information for a good or service related to real estate on a third computing device wherein the discount information at least comprises a geographical scope of the discount and an amount of the discount;
receiving from an input device at the third computing device the discount information; and
sending the discount information over a network and storing the discount information in data storage.

3. The computer-implemented method of claim 2, the method further comprising
displaying a user interface for inputting a request for discount information for a good or service related to real estate on the second computing device wherein the request at least comprises a geographical scope;
receiving from an input device at the second computing device the request for discount information; and
sending the request for discount information over a network to the first computing device.

4. The computer-implemented method of claim 1 wherein receiving discount information for a good or service related to real estate at a first computing device wherein the discount information is transmitted over a network from a plurality of computing device comprises receiving information from a multiple listing service and extracting the discount information.

5. The computer-implemented method of claim 1 wherein the discount information for goods or services related to real estate comprises discount, savings, offering, or bonus information for realtor services and builder services.

6. The computer-implemented method of claim 1 wherein the discount information for a good or service related to real estate comprises discount information for realtor services.

7. The computer-implemented method of claim 1 wherein the discount information for a good or service related to real estate comprises discount information for builder services.

8. The computer-implemented method of claim 1 wherein the discount information for a good or service related to real estate comprises discount information for builder services.

9. The computer-implemented method of claim 1 wherein the geographical scope comprises a street address including a street number and name.

10. The computer-implemented method of claim 1 wherein the geographical scope consists of a city and state.

11. The computer-implemented method of claim 1 wherein the geographical scope consists of a zip code.

12. The computer-implemented method of claim 1 wherein the geographical scope consists of a housing subdivision.

13. The computer-implemented method of claim 1 wherein the amount of the discount comprises a dollar amount.

14. The computer-implemented method of claim 1 wherein the amount of the discount comprises a percentage.

15. The computer-implemented method of claim 1 wherein the request for discount information for a good or service related to real estate is automatic when a request for information for real estate is received.

16. The computer-implemented method of claim 1 wherein receiving discount information for a good or service related to real estate comprises receiving offer information for buyer's agents and wherein receiving a request for discount information for a good or service related to real estate comprises receiving a request for offers to buyer's agents.

17. The computer-implemented method of claim 16 further comprising receiving at the first computing device verifying information to verify that the request for discount information is from a licensed realtor prior to transmitting discount information to render a user interface on the second computing device.

18. A non-transitory computer readable medium containing instructions that, when executed by a processor on a first computing device, cause the computing device to:
display a user interface for inputting a request for discount information for a good or service related to real estate on the first computing device wherein the request at least comprises a geographical scope;
receive from an input device at the first computing device the request for discount information;
send the request for discount information over a network to the first computing device; and
receive from a second computing device information to render a user interface on the first computing device wherein the information received comprises discount information including geographical information based on the request for discount information and wherein the user interface comprises a map and indicia of discount information positioned on the map based on the geographical information associated with the discount information.
